(19) United States
(12) Patent Application Publication
(10) Pub. No.: US 2009/0041436 A1
(43) Pub. Date: Feb. 12, 2009

(54) Image Recording Device and Image Recording Method

(76) Inventor: Junji Kamimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/187,778

(22) Filed: Aug. 7, 2008

(30) Foreign Application Priority Data
Aug. 10, 2007 (JP) 2007-209715

(51) Int. Cl. H04N 5/00

(52) U.S. Cl. 386/125; 386/E05.001

(57) ABSTRACT

An image recording apparatus comprising a recording unit configured to a record signal based on a signal acquired by an imaging sensor onto a disc media; a recognition unit configured to recognize a type of the disc media; a first image signal generation unit configured to generate a first image signal depending on the signal if the recognition unit judges the disc media to be a first disc media; and a second image signal generation unit configured to generate a second image signal depending on the first image signal if the recognition unit judges the disc media to be a second disc media. The recording unit records either the record signal depending on the first image signal onto the first disc media or the record signal based on the second image signal onto the second disc media.

### CROSS-REFERENCE TO RELATED APPLICATIONS

This application relates to and claims priority from Japanese Patent Application No. 2007-209715, filed on Aug. 10, 2007, the entire disclosure of which is incorporated herein by reference.

### BACKGROUND

### Description of Related Art

The invention relates to an image recording device and an image recording method, which are suitable for use in, for example, a digital video camcorder.

Conventionally, digital video camcorders in which an image acquired with a CCD (Charge-Coupled Device) is converted into an image signal of standard definition size (SD size) (768×480) and recorded on a DVD (Digital Versatile Disk) have been widely used.

In recent years, a technique has been proposed, for example, in JP Publication No. 2004-40431. With this technique, an imaging device having a moving picture mode and a still picture mode takes an image of an object at a wide angle with a CCD, and either creates a moving picture by clipping a portion from the image or creates a still picture using the entire image or a larger portion than that of the moving picture.

Also, digital video camcorders that record on a Blu-ray Disc (BD) (Trademark), which is a mass storage medium, have appeared, so images acquired with a CCD can be converted into an image signal of high-quality high-definition size (HD size) (1920×540) for recording.

### SUMMARY

Meanwhile, users may have various wants, like wanting to choose one of a DVD and a BD depending on their intended use, or wanting to record data onto DVDs they have previously purchased in bulk.

The invention has been made in light of the above situation, and its object is to provide a picture recording device and a picture recording method with improved usability.

To solve the above problem, the invention provides an image recording device comprising: a recording unit configured to record a record signal based on a signal acquired by an imaging sensor onto a disc media; a recognition unit configured to recognize a type of the disc media; a first image signal generation unit configured to generate a first image signal depending on the signal if the recognition unit judges the disc media to be a first disc media; and a second image signal generation unit configured to generate a second image signal depending on the first image signal if the recognition unit judges the disc media to be a second disc media that differs from the first disc media. With this configuration, the recording unit records either the record signal depending on the first image signal onto the first disc media or the record signal depending on the second image signal onto the second disc media.

Accordingly, plural types of image signal can be generated in accordance with the capacity of the disc media, so a user can choose, when recording, either the first disc media or the second disc media depending on his/her intended use.

The invention also provides an image recording method performed by an image recording device comprising: recognizing a type of a disc media placed into the image recording device; generating a first image signal depending on a signal acquired by an image sensor if the disc media is judged to be a first disc media; generating a second image signal depending on the first image signal generated if the disc media is judged to be a second disc media that differs from the first disc media; and recording either a record signal depending on the first image signal onto the first disc media or a record signal depending on the second image signal onto the second disc media.

Accordingly, plural types of image signal can be generated accordance with the capacity of the disc media, so a user can choose, when recording, either the first disc media or the second disc media depending on his/her intended use.

The invention also provides an image recording device comprising: a recording unit configured to record a record signal based on a signal acquired with an imaging sensor onto a disc media; a recognition unit configured to recognize a type of the disc media; a first image signal generation unit configured to generate a first image signal depending on the signal if the recognition unit judges the disc media to be a first disc media; and a second image signal generation unit configured to generate a second image signal based on the signal if the recognition unit judges the disc media to be a second disc media that differs from the first disc media. With this configuration, the recording unit records either the record signal depending on the first image signal onto the first disc media or the record signal depending on the second image signal onto the second disc media.

Accordingly, plural types of image signal can be generated in accordance with the capacity of the disc media, so a user can choose when recording, either the first disc media or the second disc media depending on his/her intended use.

With the invention, an image recording device and image recording method with improved user facilities is achieved.

### BRIEF DESCRIPTION OF THE DRAWINGS

FIG. 1 is a block diagram showing a schematic configuration of a digital video camcorder according to an embodiment of the invention.

FIG. 2 is a block diagram showing a schematic configuration of a camera signal processing unit according to an embodiment of the invention.

FIG. 3 is a block diagram showing a schematic configuration of a control microcomputer unit according to an embodiment of the invention.

FIG. 4 is a flowchart showing an image recording processing routine according to an embodiment of the invention.

### DETAILED DESCRIPTION OF PREFERRED EMBODIMENTS

An embodiment of the invention will be described in detail with reference to the drawings.

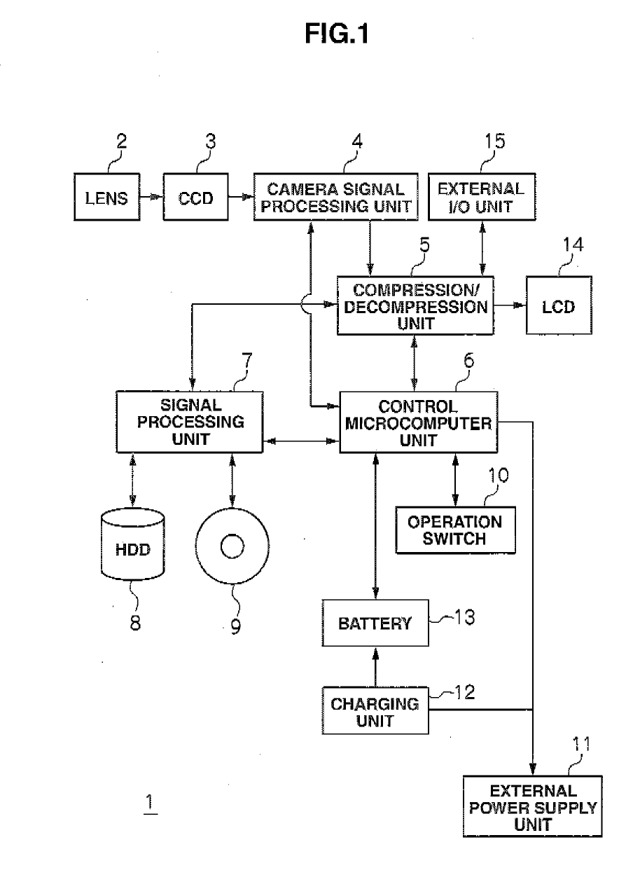

FIG. 1 is a schematic diagram of a digital video camcorder 1 in this embodiment. The digital video camcorder 1 includes a lens 2, an imaging sensor (CCD) 3, a camera signal processing unit 4, compression/decompression unit 5, a control microcomputer 6, a signal processing unit 7, a hard disk drive (HDD) 8, a disc media drive (not shown) for placing a disc media 9, an operation switch unit 10, an external power supply unit 11, a battery charger 12, a battery 13, a liquid crystal display (LCD) 14, and an external I/O unit 15.

The imaging sensor 3 converts an image acquired through the lens 2 into an electric signal and then sends the electric signal to the camera signal processing unit 4. The camera signal processing unit 4 converts the electric signal into an image signal and then sends the image signal to the compression/decompression unit 5.

The compression/decompression unit 5 sends the image signal to the LCD 14. Accordingly, an image based on the image signal is displayed on the LCD 14.

Further, the compression/decompression unit 5 converts the image signal into a digital image signal by way of compressing the image signal, and then sends the digital image signal to the signal processing unit 7. The compression/decompression unit 5 also converts an externally input image signal sent via the external I/O unit 15 into a digital image signal and then sends the digital image signal to the signal processing unit 7.

The signal processing unit 7 records the sent digital image signal on the hard disk drive 8, or the disc media 9 such as a Blu-ray Disc or a DVD placed into the disc media drive. The signal processing unit 7 also executes inter-media copy processing, for example, reads a digital image signal recorded on the disc media 9 such as a Blu-ray Disc or DVD and records that digital image signal on the hard disk drive 8.

The signal processing unit 7 reads the digital image signal recorded onto the hard disk drive 8 or the disc media 9, such as a Blu-ray Disc or a DVD, and then sends that digital image signal to the compression/decompression unit 5. In response to this, the compression/decompression unit 5 converts digital image signal to its original image signal by way of decompressing the digital image signal, and sends the original image signal to the LCD 14. In this way, an image based on that image signal is displayed on the LCD 14.

The external power supply unit 11 supplies power from an external source, for example, an AC source to. The charging unit 12 receives the power supplied from the external power supply unit 11 and charges the battery 13. As a result, the digital video camcorder 1 operates using the externally supplied power when the power is supplied from the external power supply unit 11, whereas the digital video camcorder 1 operates using electric power supplied from the battery 13 when the power is not externally supplied. All components necessary for charging do not have to be built in the digital video camcorder 1, and some or all of the components necessary for charging may be installed outside the digital video camcorder 1.

The control microcomputer 6 controls, in accordance with user operation through the operation switch 10, the camera signal processing unit 4, the compression/decompression unit 5, the signal processing unit 7, and the battery 12. Control under the control microcomputer 6 will be described later.

In FIG. 1, the components are separately shown for ease of explanation. However, the components may also be integrated in a single chip according to the circuit design. In some cases, that configuration is advantageous in terms of ease of control and space in the circuit design. The LCD 14 may be any type of device for displaying images, such as an organic EL display.

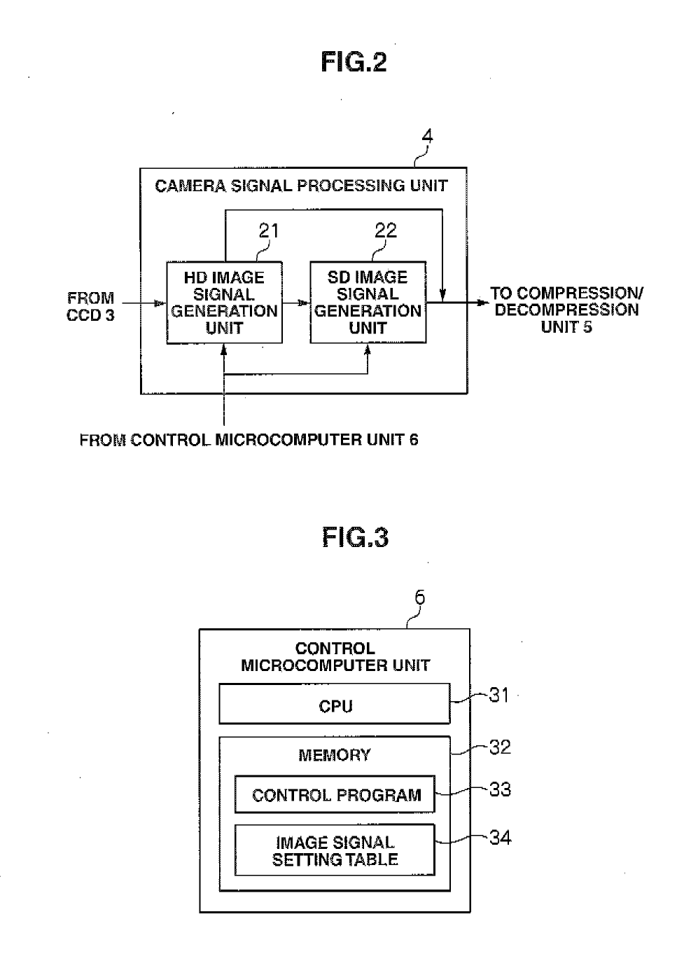

FIG. 2 is a schematic diagram of the camera signal processing unit 4 in this embodiment. The camera signal processing unit 4 includes an HD image signal generation unit 21 for generating an image-signal of HD size (hereinafter referred to as an “HD image signal”) and an SD image signal generation unit 22 for generating an image signal of SD size (hereinafter referred to as an “SD image signal”).

The HD image signal generation unit 21 executes upon receipt of a command from the control microcomputer unit 6, various kinds of image transformation on an electric signal sent from the imaging sensor 3 to generate an HD image signal. The HD image signal generation unit sends, under control of the control microcomputer unit 6, the HD image signal to either the SD image signal generation unit 22 or to the compression/decompression unit 5 as the digital image signal as discussed above.

The SD image signal generation unit 22 executes, upon receipt of a command from the control microcomputer unit 6, pixel number conversion processing on the HD image signal sent from the HD image signal generation unit 21 to generate an SD image signal, and sends the SD image signal as the foregoing digital image signal to the compression/decompression unit 5.

More specifically, the SD image signal generation unit 22 divides, by two, the sampling frequency for, for example 768 pixels (horizontal direction) or 480 pixels (vertical direction), executes bandwidth limitation processing by removing the frequency component higher than the result of that division, and further executes downsizing (sampling) processing for downsizing the number of pixels in the horizontal direction in the HD image signal from 1920 pixels to 768 pixels, and the number of pixels in the vertical direction in the HD image signal from 540 pixels to 480 pixels.

This invention may also be configured so that the HD image signal generation unit 21 sends the electric signal sent from the imaging sensor 3 under control of the control microcomputer unit 6 without executing image transformation processing on the electric signal sent and the SD image signal generation unit 22 generates an SD image signal by executing various kinds of image transformation processing on the electric signal sent from the HD image signal generation unit 21 and sends the SD image signal as the digital image signal to the compression/decompression unit 5.

The invention may also be configured so that the HD image signal generation unit 21 and the SD image signal generation unit 22 are arranged in parallel, and the SD image signal generation unit 22 generates an SD image signal by executing various kinds of image transformation processing on an electric signal sent from the imaging sensor 3, and sends that SD image signal as the digital image signal to the compression/decompression unit 5.

FIG. 3 is a schematic diagram of the control microcomputer unit 6 in this embodiment. The control microcomputer unit 6 includes a CPU (Central Processing Unit) 31, which is a microcomputer for comprehensively controlling the digital video camcorder 1, and memory 32. The memory 32 stores a control program 33 for the CPU 31 to execute various kind of control, and an image signal setting table 34 in which the types of image signals to be recorded are defined.

In the digital video camcorder 1, whether an image signal is to be recorded on the disc media 9 as an HD image signal or an SD image signal is set in advance by having a user operate the operation switch 10, and the setting is stored in the image signal setting table 34.

Next, image recording processing in the control microcomputer unit 6 in the digital video camcorder 1 will be described,

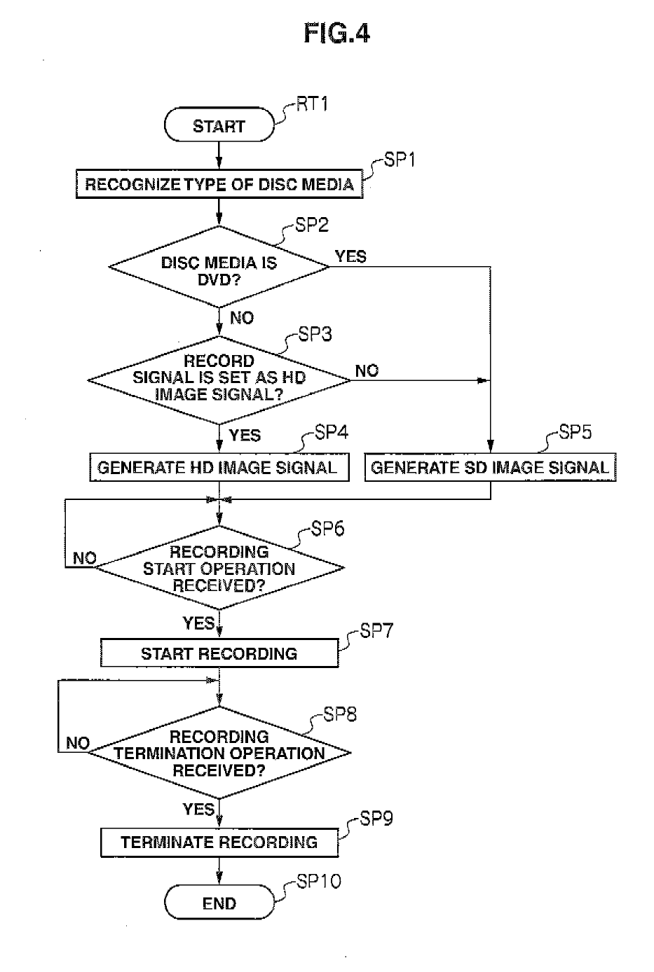

FIG. 4 shows an example of a flowchart showing a specific sequence for image recording processing executed by the CPU 31 in the control microcomputer unit 6 in the digital video camcorder 1.

Electric power is supplied, for example from the external power supply unit 11, to the CPU 31 in the control microcomputer unit 6. The CPU 31 in the control microcomputer unit 6 executes, after recognizing the disc media 9 inserted, an image recording program included in the control program 33 according to the image recording routine RT1 shown in FIG. 4, and sends a command to the signal processing unit 7 to recognize the type of disc media 9 (SP1).

Subsequently, the CPU 31 in the control microcomputer unit 6 checks whether or not the disc media 9 is a DVD (SP2). If the disc media 9 is not a DVD (SP2: NO), i.e., the disc media 9 is a Blu-ray Disc, the CPU 31 in the control microcomputer unit 6 refers to the image signal setting table 34 and checks whether or not the image signal to be recorded on the disc media 9, which is a Blu-ray Disc, is set as an HD image signal (SP3).

Then, if the image signal to be recorded on the disc media 9 of Blu-ray disc is set as an HD image signal (SP3: YES), the CPU 31 in the control microcomputer unit 6 sends a command to the HD image signal generation unit 21 in the signal processing unit 7 to cause the HD image signal generation unit 21 to generate an HD image signal and send that HD image signal as the foregoing image signal to the compression/decompression unit 5, not to the SD image signal generation unit 22 (SP4).

In other words, the CPU 31 in the control microcomputer unit 6 has the HD image signal generation unit 21 send, after generating an HD image signal, this signal as the foregoing image signal to the compression/decompression unit 5, not causing the camera signal processing unit 4 to execute bandwidth limitation processing and downsizing processing.

Meanwhile, if the disc media 9 is a DVD (SP2: YES), or if the image signal to be recorded on the Blue-ay Disc media 9 is not set as an HD image signal (SP3: NO) but set as an SD image signal, the CPU 31 in the control microcomputer unit 6 sends a command to the HD image signal generation unit 21 in the signal processing unit 7 to cause the HD image signal generation unit 21 to generate an HD image signal and send it to the SD image signal generation unit 22.

After that, the CPU 31 in the control microcomputer unit 6 sends a command to the SD image signal generation unit 22 in the signal processing unit 7 to cause the SD image signal generation unit 22 to generate an SD image signal based on the sent HD image signal, and send that SD image signal as the above mentioned image signal to the compression/decompression unit 5 (SP5).

In other words, the CPU 31 in the control microcomputer unit 6 has, after generating an HD image signal, the camera signal processing unit 4 execute bandwidth limitation processing and downsizing processing, convert the HD image signal into an SD image signal, and send that SD image signal as the foregoing image signal to the compression/decompression unit 5.

The CPU 31 in the control microcomputer unit 6 thereafter sends a command to the compression/decompression unit 5 to cause the compression/decompression unit 5 to send the received HD image signal or SD image signal as the above mentioned image signal to the LCD 14. As a result, an image formed with the number of pixels corresponding to the HD image signal or SD image signal is displayed on the LCD 14.

After that, the CPU 31 in the control microcomputer unit 6 waits for a command to start recording received from the operation switch 10 from the user operation through the operation switch 10 in standby mode (SP6).

The CPU 31 in the control microcomputer unit 6 sends, upon receipt of the command to start recording from the operation switch 10 (SP6: YES), a command to the compression/decompression unit 5 and the signal processing unit 7 to start recording a digital image signal based on the HD image signal or SD image signal on the hard disk drive 8, or the Blu-ray Disc or DVD disc media 9 (SP7).

After that, the CPU 31 in the control microcomputer unit 6 waits for a command to terminate recording received from the operation switch 10 from the user operating the operation switch 10 in standby mode (SP8).

The CPU 31 in the control microcomputer unit 6 sends, upon receipt of the command to terminate recording from the operation switch 10 (SP8: YES), a command to the compression/decompression unit 5 and signal processing unit 7 to terminate recording the digital image signal based on the HD image signal or the SD image signal on the hard disk drive 8 or the disc media 9 such as a Blu-ray Disc or a DVD, (SP9).

After that, the CPU 31 in the control microcomputer unit 6 terminates the image recording processing routine RT1 shown in FIG. 4 (SP10).

With the above described configuration, the digital video camcorder 1 recognizes the type of the disc media 9; generates an HD image signal if the disc media 9 is a Blu-ray Disc; and records a digital image signal based on the generated HD image signal on the Blu-ray Disc. In contrast, if the disc media 9 is a DVD, the digital video camcorder 1 generates an HD image signal and generates an SD image signal based on the generated HD image signal, and records a digital image signal based on the generated SD image signal on the DVD.

As a result, two types of image signals, i.e., an HD image signal and an SD image signal can be generated, taking the capacity of the disc media 9 into account, so a user can choose a DVD or a Blu-ray Disc to use for recording depending his/her intended use. With that configuration, usability of the digital video camcorder 1 is improved.

In addition, in the digital video camcorder 1, if the disc media 9 is a Blu-ray Disc and the image signal to be recorded on that Blu-ray Disc is set as an SD image signal, an SD image signal is generated and a digital image signal based on the generated SD image signal is recorded on the Blu-ray Disc. This configuration makes recording for a longer time possible, if the user wants to do so.

In the above described embodiment, an HD image signal or an SD image signal is generated, depending on whether the disc media 9 is a Blu-ray Disc or a DVD. However, the invention is not limited to that embodiment, and may also be utilized in the case of generating an image signal corresponding to a next-generation disc media.

In the above described embodiment, two types of image signals, i.e., an HD image signal and an SD image signal, are generated. However, the invention is not limited to that embodiment, and may generate more than two types of image signal in accordance with the types of disc media, and record data on more than two types of disc media.

The invention can be widely utilized in image recording equipment other than digital video camcorder.

What is claimed is:

1. An image recording device comprising:
a recording unit configured to record a record signal based on a signal acquired by an imaging sensor on a disc media;
a recognition unit configured to recognize a type of the disc media;
a first image signal generation unit configured to generate a first image signal based on the signal if the recognition unit judges the disc media to be a first disc media; and
a second image signal generation unit configured to generate a second image signal based on the first image signal generated by the first image signal generation unit if the recognition unit judges the disc media to be a second disc media that differs from the first disc media,
wherein the recording unit either records the record signal depending on the first image signal onto the first disc media or records the record signal depending on the second image signal on the second disc media.

2. The image recording device according to claim 1,
wherein the second image signal generation unit generates the second image signal if the record signal depending on the second image signal is set to be recorded, and
wherein the recording unit records the record signal depending on the second image signal onto either the first disc media or the second disc media.

3. The image recording device according to claim 1, further comprising a hard disk drive, wherein the recording unit records the record signal depending on the first image signal or the second image signal onto the hard disk drive.

4. The image recording device according to claim 17 wherein the second image signal generation unit executes bandwidth limitation processing on the first image signal and executes downsizing processing to generate the second image signal.

5. The image recording device according to claim 1,
wherein the first disc media is a Blu-ray Disc,
wherein the second disc media is a DVD,
wherein the first image signal is an image signal of high-definition size, and
wherein the second image signal is an image signal of standard-definition size.

6. An image recording method performed by an image recording device, comprising:
recognizing a type of a disc media placed into the image recording device;
generating a first image signal based on a signal acquired with an imaging sensor if the disc media is judged to be a first disc media;
generating a second image signal based on the first image signal generated if the disc media is judged to be a second disc media that differs from the first disc media; and
recording either a record signal depending on the first image signal onto the first disc media or a record signal depending on the second image signal onto the second disc media.

7. The image recording method according to claim 6,
wherein the second image signal is generated if the record signal depending on the second image signal is set to be recorded, and
wherein the record signal depending on the second image signal is recorded onto either the first disc media or the second disc media.

8. The image recording method according to claim 6, wherein the record signal depending on the generated first image signal or the generated second image signal is recorded on a hard disk drive.

9. The image recording method according to claim 6, wherein the second image signal is generated by executing bandwidth limitation processing and downsizing processing on the first image signal.

10. The image recording method according to claim 6,
wherein the first disc media is a Blu-ray disc,
wherein the second disc media is a DVD,
wherein the first image signal is an image signal of high-definition size, and
wherein the second image signal is an image signal of standard-definition size.

11. An image recording device comprising:
a recording unit configured to record a record signal based on a signal acquired with an imaging sensor onto a disc media;
a recognition unit configured to recognize a type of the disc media;
a first image signal generation unit configured to generate a first image signal depending on the signal if the recognition unit judges the disc media to be a first disc media; and
a second image signal generation unit configured to generate a second image signal depending on the signal if the recognition unit judges the disc media to be a second disc media that differs from the first disc media,
wherein the recording unit records either the record signal depending on the first image signal onto the first disc media or the record signal depending on the second image signal onto the second disc media.
